(19) United States
(12) Patent Application Publication
(10) Pub. No.: US 2013/0270337 A1
(43) Pub. Date: Oct. 17, 2013

(54) SYSTEM FOR MANAGING THE NUTRITIONAL CONTENT FOR NUTRITIONAL SUBSTANCES

(71) Applicant: Eugenio Minvielle, RYE, NY (US)

(72) Inventor: Eugenio Minvielle, RYE, NY (US)

(21) Appl. No.: 13/485,850

(22) Filed: May 31, 2012

Related U.S. Application Data
(60) Provisional application No. 61/624,993, filed on Apr. 16, 2012.
(60) Provisional application No. 61/624,999, filed on Apr. 16, 2012.
(60) Provisional application No. 61/625,009, filed on Apr. 16, 2012.

(51) Int. Cl. G06F 17/00; G09F 3/00

(52) U.S. Cl. 235/375; 40/299.01

(57) ABSTRACT

Disclosed herein is an information encoding, marking, tracking, and transmission system for information related to nutritional substances, including nutritional content. Upon the creation of a nutritional substance, whether grown, raised, caught, collected or synthesized, information regarding the nutritional substance is accumulated, encoded and referenced to the particular nutritional substance. This information can be marked directly on the nutritional substance, but can instead be stored elsewhere, and referenced to the nutritional substance by means of a marking, unique identifier, a unique inherent property, unique genetic attribute, or an induced genetic attribute. A consumer of the nutritional substance can use this reference to retrieve the information regarding the creation of the particular nutritional substance.

### CROSS REFERENCE TO RELATED APPLICATIONS OR PRIORITY CLAIM

This application claims benefit under 35 U.S.C. 119(e) of U.S. Provisional Patent Application Ser. No. 61/624,993 filed Apr. 16, 2012; U.S. Provisional Patent Application Ser. No. 61/624,999, filed Apr. 16, 2012; and U.S. Provisional Patent Application, 61/625,009, filed Apr. 16, 2012, the contents of which are incorporated herein by reference in their entirety.

### FIELD OF THE INVENTION

The present inventions relate to an integrated system for collecting, transmitting and acting upon information regarding the nutritional content of nutritional substances.

### BACKGROUND OF THE INVENTION

Nutritional substances are traditionally grown (plants), raised (animals) or synthesized (synthetic compounds). Additionally, nutritional substances can be found in a wild, non-cultivated form, which can be caught or collected. While the collectors and creators of nutritional substances generally obtain and/or generate information about the source, history, caloric content and/or nutritional content of their products, they generally do not pass such information along to the users of their products. One reason is the nutritional substance industries have tended to act like “silo” industries. Each group in the food and beverage industry: growers, packagers, processors, distributors, retailers, and preparers work separately, and either shares no information, or very little information, between themselves. There is generally no consumer access to, and little traceability of, information regarding the creation and/or origin, preservation, processing, preparation, or consumption of nutritional substances. It would be desirable for such information be available to the consumers of nutritional substances, as well as all participants in the food and beverage industry—the nutritional substance supply system.

While the nutritional substance supply system has endeavored over the last 50 years to increase the caloric content of nutritional substances produced (which has help reduce starvation in developing countries, but has led to obesity problems in developed countries), maintaining, or increasing, the nutritional content of nutritional substances has been a lower priority. Caloric content refers to the energy in nutritional substances, commonly measured in calories. The caloric content could be represented as sugars and/or carbohydrates in the nutritional substances. The nutritional content of foods and beverages, as used herein, refers to the non-caloric content of these nutritional substances which are beneficial to the organisms which consume these nutritional substances. For example, the nutritional content of a nutritional substance could include vitamins, minerals, proteins, and other non-caloric components which are necessary, or at least beneficial, to the organism consuming the nutritional substances.

While there has recently been greater attention by consumer organizations, health organizations and the public to the nutritional content of foods and beverages, the food and beverage industry has been slow in responding to this attention. One reason for this may be that since the food and beverage industry operates as silos of those who create nutritional substances, those who preserve and transport nutritional substances, those who transform nutritional substances, and those who finally prepare the nutritional substances for consumption by the consumer, there has been no coordination of management of nutritional content. While each of these silo industries may be able to maintain or increase the nutritional content of the foods and beverages they handle, each silo industry has only limited information and control of the nutritional substances they receive, and the nutritional substances they pass along.

As consumers better understand their need for nutritional substances with higher nutritional content, they will start demanding that the food and beverage industry offer products which include higher nutritional content, and/or at least information regarding nutritional content of such products. In fact, consumers are already willing to pay higher prices for higher nutritional content. This can be seen at high-end grocery stores which offer organic, minimally processed, fresh, non-adulterated nutritional substances. Further, as societies and governments seek to improve their constituents' health and lower healthcare costs, incentives and/or mandates will be given to the food and beverage industry to track, maintain, and/or increase the nutritional content of nutritional substances they handle. There will be a need, not only within each food and beverage industry silo to maintain or improve the nutritional content of their products, but an industry-wide solution to allow the management of nutritional content across the entire cycle from creation to consumption. In order to manage the nutritional content of nutritional substances across the entire cycle from creation to consumption, the nutritional substance industry will need to identify, track, measure, estimate, preserve, transform, condition, and record nutritional content for nutritional substances. Of particular importance is the measurement, estimation, and tracking of changes to the nutritional content of a nutritional substance from creation to consumption. This information could be used, not only by the consumer in selecting particular nutritional substances to consume, but could be used by the other food and beverage industry silos, including creation, preservation, transformation, and conditioning, to make decisions on how to create, handle and process nutritional substances. Additionally, those who sell nutritional substances to consumers, such as restaurants and grocery stores, could market and price nutritional substances with higher nutritional content, or minimally degraded nutritional content.

For example, the grower of sweet corn generally only provides basic information as the variety and grade of its corn to the packager, who preserves and ships the corn to a producer for use in a ready-to-eat dinner. The packager may only tell the producer that the corn has been frozen as loose kernels of sweet corn. The producer may only provide the consumer with rudimentary instructions how to cook or reheat the ready-to-eat dinner in a microwave oven, toaster oven or conventional oven, and only tell the consumer that the dinner contains whole kernel corn among the various items in the dinner. Finally, the consumer of the dinner will likely keep her opinions on the quality of the dinner to herself, unless it was an especially bad experience, where she might contact the producer's customer support program to complain. Very minimal, or no, information on the nutritional content of the ready-to-eat dinner is passed along to the consumer. The consumer knows essentially nothing about changes (generally degradation) to the nutritional content of the sweet corn from creation, processing, packaging, cooking, preservation, preparation by consumer, and finally consumption by the consumer.

Consumers' needs are changing as consumers are demanding healthier foods, such as “organic foods.” Customers are also asking for more information about the nutritional substances they consume, such as specific characteristics' relating not only to nutritional content, but to allergens or digestive intolerances. For example, nutritional substances which contain lactose, gluten, nuts, dyes, etc. need to be avoided by certain consumers. However, the producer of the ready-to-eat dinner, in the prior example, has very little information to share other than possibly the source of the elements of the ready-to-eat dinner and its processing steps in preparing the dinner. Generally, the producer of the ready-to-eat dinner does not know the nutritional content and organoleptic state of the product after it has been reheated or cooked by the consumer. For example, the consumer may want to know what proportion of organoleptic properties and/or nutritional content the corn in the ready-to-eat dinner remain after cooking or reheating, and the change in nutritional content (usually a degradation). There is a need to preserve, measure, estimate, store and/or transmit such nutritional content information throughout the nutritional substance supply system.

The caloric and nutritional content information for a prepared food that is provided to the consumer is often minimal. For example, when sugar is listed in the ingredient list, the consumer generally does receive any information about the source of the sugar, which can come from a variety of plants, such as sugarcane, beets, or corn, which will affect its nutritional content. Conversely, some nutritional information that is provided to consumers is so detailed, the consumer can do little with it. For example, this of ingredients is from a nutritional label on a consumer product: Vitamins—A 355 IU 7%, E 0.8 mg 4%, K 0.5 mcg, 1%, Thiamin 0.6 mg 43%, Riboflavin 0.3 mg 20%, Niacin 6.0 mg 30%, B6 1.0 mg 52%, Foliate 31.5 mcg 8%, Pantothenic 7%; Minerals Calcium 11.6 1%, Iron 4.5 mg 25%, 211 mg 53%, Phosphorus 349 mg 35%, Potassium 476 mg 14%, Sodium 58.1 mg 2%, Zinc 3.7 mg 24%, Copper 0.5 mg 26%, Manganese 0.8 mg 40%, Selenium 25.7 mcg 37%; Carbohydrate 123 g, Dietary fiber 12.1 g, Saturated fat 7.9 g, Monosaturated Fat 2.1 g, Polysaturated Fat 3.6 g, Omega 3 fatty acids 108 g, Omega 6 fatty acids 3481, Ash 2.0 g and Water 17.2 g. (%=Daily Value). There is a need to provide information about nutritional substances in a meaningful manner. Such information needs to be presented in a manner that meets the specific needs of a particular consumer. For example, consumers with a medical condition, such as diabetes, would want to track specific information regarding sugar and nutrients in the foods and beverages they consume.

If fact, each silo in the food and beverage industry already creates and tracks some information, including caloric and nutritional information, about their product internally. For example, the farmer who grew the corn knows the variety of the seed, condition of the soil, the source of the water, the fertilizers and pesticides used, and can measure the caloric and nutritional content at creation. The packager of the corn knows when it was picked, how it was transported to the packaging plant, how the corn was preserved and packaged before being sent to the ready-to-eat dinner producer, when it was delivered to the producer, and what degradation to caloric and nutritional content has occurred. The producer knows the source of each element of the ready-to-eat dinner, how it was processed, including the recipe followed, and how it was preserved and packaged for the consumer. Not only does such a producer know what degradation to caloric and nutritional occurred, the producer can modify its processing and post-processing preservation to minimally affect nutritional content. The preparation of the nutritional substance for consumption can also degrade the nutritional content of nutritional substances. Finally, the consumer knows how she prepared the dinner, what condiments were added, and whether she did or did not enjoy it.

If there was a mechanism to share this information, the quality of the nutritional substances, including caloric and nutritional content, could be preserved and improved. Consumers could be better informed about nutritional substances they select and consume, including the state of the nutritional substance throughout its lifecycle from creation to consumption. The efficiency and cost effectiveness of nutritional substances could also be improved. Feedback within the entire chain from creator to consumer could provide a closed-loop system that could improve quality (taste, appearance, and caloric and nutritional content), efficiency, value and profit. For example, in the milk supply chain, at least 10% of the milk produced is wasted due to safety margins included in product expiration dates. The use of more accurate tracking information, measured quality (including nutritional content) information, and historical environmental information could substantially reduce such waste. Collecting, preserving, measuring and/or tracking information about a nutritional substance in the nutritional substance supply system, would allow needed accountability. There would be nothing to hide.

As consumers are demanding more information about what they consume, they are asking for products that have higher nutritional content and more closely match good nutritional requirements, and would like nutritional products to actually meet their specific nutritional requirements. While grocery stores, restaurants, and all those who process and sell food and beverages may obtain some information from current nutritional substance tracking systems, such as labels, these current systems can provide only limited information.

Nutritional substances collectors and/or producers, such as growers (plants), ranchers (animals) or synthesizer (synthetic compounds), routinely create and collect information about their products, however, that information is generally not accessible by their customers. Even if such producers wished to provide such information to their customers, there is no current method of labeling, encoding or identifying each particular product to provide such information (even though all plants, animals and in general, nutritional substances have a natural fingerprint). While there are limited methods and systems available, they are excessively costly, time consuming, and do not trace, or provide access to, the nutritional substance organoleptic and/or nutritional state across the product's lifecycle. Current labels for such products include package labels, sticker labels and food color ink labels. These labels generally are applied to all similar products and cannot identify each particular product, only variety of products, such as apple banana, but not a particular banana.

An important issue in the creation, preservation, transformation, conditioning, and consumption of nutritional substances are the changes that occur in nutritional substances due to a variety of internal and external factors. Because nutritional substances are composed of biological, organic, and/or chemical compounds, they are generally subject to degradation. This degradation generally reduces the nutritional, organoleptic, and/or aesthetic values of nutritional substances. While not always true, nutritional substances are best consumed at their point of creation. However, being able to consume nutritional substances at the farm, at the slaughterhouse, at the fishery, or at the food processing plant is at least inconvenient, if not impossible. Currently, the food and beverage industry attempts to minimize the loss of nutritional value (often through the use of additives or preservatives), and/or attempts to hide this loss of nutritional value from consumers.

Overall, the examples herein of some prior or related systems and their associated limitations are intended to be illustrative and not exclusive. Other limitations of existing or prior systems will become apparent to those of skill in the art upon reading the following Detailed Description.

### OBJECTS OF THE INVENTION

It is an object of the present invention to obtain information as to the creation/origin of a nutritional substance, whether it is grown, caught, raised, or synthesized. Such information could be accessed by users or consumers of the nutritional substances by means of identification of specific nutritional substances. The means for identification can take the form tag of a label, wherein such a label can be attached to the nutritional substance. Such a label can be made up of a material attached to the nutritional substance or could be encoded directly on the nutritional substance.

It is an object of the present invention to obtain information as to the creation/origin of a nutritional substance, whether it is grown, raised, caught, recollected or synthesized. Such information could be accessed by users or consumers of the nutritional substances by means of identification of specific nutritional substances. The means for identification of a nutritional substance is done by a unique attribute of the nutritional substance is identified that can be used to reference the creation/origin information. Alternately, identification can be done by modifying the nutritional substance in a fashion which does not affect the nutritional quality or taste of the nutritional substance that allows the nutritional substance to be uniquely identified to reference the creation information.

It is an object of the present invention to obtain information as to the creation/origin of a nutritional substance, whether it is grown, raised, caught, collected, or synthesized. Such information could be accessed by users or consumers of the nutritional substances by means of identification of specific nutritional substances. The means for identification of a nutritional substance is done by a unique genetic attribute of the nutritional substance is identified that can be used to reference the creation information. Alternately, identification can be done by modifying the genetic attributes nutritional substance in a fashion which does not affect the nutritional quality or taste of the nutritional substance that allows the nutritional substance to be uniquely identified to reference the creation information.

It is an object of the present invention to minimize and/or track degradation of nutritional, organoleptic, and/or aesthetic value of nutritional substances, and/or collect, store, and/or transmit information regarding this degradation.

### SUMMARY OF THE INVENTION

In an embodiment of the present invention, information as to the creation/origin of a nutritional substance, whether it is grown, caught, raised, or synthesized is obtained and stored. The means for identification can take the form tag of a label, wherein such a label can be attached to the nutritional substance. Such a label can be made up of a material attached to the nutritional substance or could be encoded directly on the nutritional substance.

In another embodiment of the present invention, information as to the creation/origin of a nutritional substance, whether it is grown, raised, caught, recollected or synthesized is referenced by means of identification of specific nutritional substances. The means for identification of a nutritional substance is done by a unique attribute of the nutritional substance is identified that can be used to reference the creation/origin information. Alternately, identification can be done by modifying the nutritional substance in a fashion which does not affect the nutritional quality or taste of the nutritional substance that allows the nutritional substance to be uniquely identified to reference the creation information.

In another embodiment of the present invention, information as to the creation/origin of a nutritional substance, whether it is grown, raised, caught, collected, or synthesized is referenced by identification of a nutritional substance by a unique genetic attribute of the nutritional substance is identified that can be used to reference the creation information. Alternately, identification can be done by modifying the genetic attributes nutritional substance in a fashion which does not affect the nutritional quality or taste of the nutritional substance that allows the nutritional substance to be uniquely identified to reference the creation information.

The an embodiment of the present invention provides a system for the creation, collection, storage, transmission, and/or processing of information regarding nutritional substances so as to improve, maintain, or minimize degradation of nutritional, organoleptic, and/or aesthetic value of nutritional substances. Additionally, the present invention provides such information for use by the creators, preservers, transformers, conditioners, and consumers of nutritional substances. The nutritional information creation, preservation, and transmission system of the present invention should allow the nutritional substance supply system to improve its ability to minimize degradation of nutritional, organoleptic and/or aesthetic value of the nutritional substance, and/or inform the consumer about such degradation. While the ultimate goal of the nutritional substance supply system is to minimize degradation of nutritional, organoleptic and/or aesthetic value, an interim goal should be providing consumers with significant information regarding degradation of nutritional substances consumers select and consume. Entities within the nutritional substance supply system who provide such information regarding nutritional substance degradation will be able to differentiate their products from those who obscure and/or hide such information. Additionally, such entities should be able to charge a premium for products which either maintain their nutritional, organoleptic, and/or aesthetic value, or supply more complete information.

Other advantages and features will become apparent from the following description and claims. It should be understood that the description and specific examples are intended for purposes of illustration only and not intended to limit the scope of the present disclosure.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 shows a schematic functional block diagram of a nutritional substance supply relating to the present invention;

FIG. 2 shows a graph representing a value of a nutritional substance which changes according to a change of condition for the nutritional substance;

FIG. 3 shows a schematic functional block diagram of the creation module 200 according to the present invention;

FIG. 4 shows a schematic functional block diagram of the creation module 200 according to an alternate embodiment of the present invention;

FIG. 5 shows a schematic functional block diagram of the creation module 200 according to an alternate embodiment of the present invention;

FIG. 6 shows a schematic functional block diagram of the creation module 200 according to an alternate embodiment of the present invention; and

FIG. 7 shows a schematic functional block diagram of the creation module 200 according to an alternate embodiment of the present invention.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

The following discussion provides a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “controller,” “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

In some instances, the interconnection between modules is the internet, allowing the modules (with, for example, WiFi capability) to access web content offered through various web servers. The network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

The modules in the systems can be understood to be integrated in some instances and in particular embodiments, only particular modules may be interconnected.

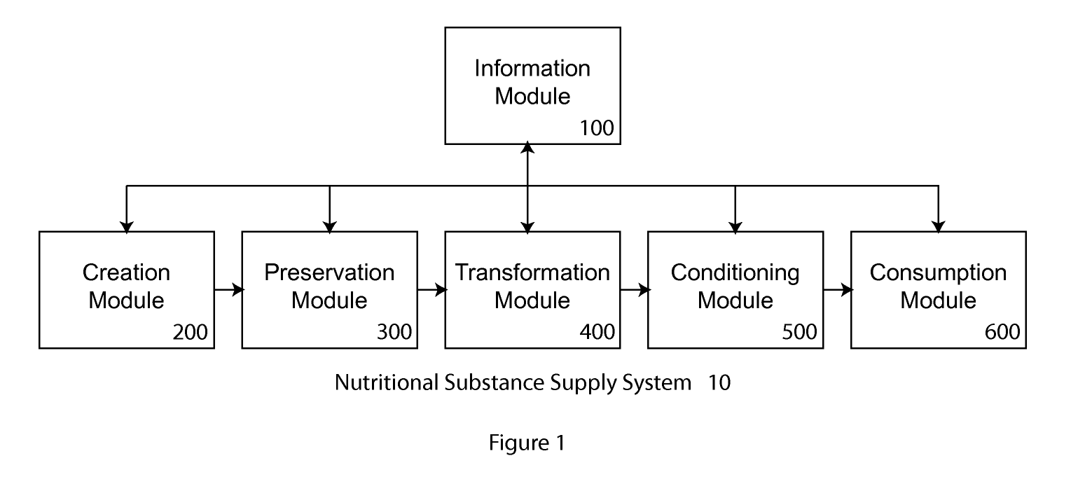

FIG. 1 shows the components of a nutritional substance industry 10. It should be understood that this could be the food and beverage and beverage ecosystem for human consumption, but could also be the feed industry for animal consumption, such as the pet food industry, or even the agricultural ecosystem for the cultivation of plants. A goal of the present invention for nutritional substance industry 10 is to create, preserve, transform and trace the qualitative, organoleptic and nutritional properties of nutritional substances through their creation, preservation, transformation, conditioning and consumption. While the nutritional substance industry 10 can be composed of many companies or businesses, it can also be integrated into combinations of business serving many roles, or can be one business or even individual.

Module 200 is the creation module. This can be system, organization, or individual which creates and/or originates nutritional substances. Examples of this module include a farm which grows produce. It can be a ranch which raises beef. It can be an aquaculture far for growing shrimp. It could be a factory with synthesizes nutritional compounds. It could be collector of wild truffles. If could be a deep sea crab trawler.

Preservation module 300 is a preservation system for preserving and protecting the nutritional substances created by creation module 200. Once the nutritional substance has been created, generally, it will need to be packaged in some manner for its transition to other modules in the nutritional substances industry 10. While preservation module 300 is shown in a particular position in the nutritional substance industry 10, following the creation module 200, it should be understood that the preservation module 300 actual can be placed anywhere nutritional substances need to be preserved during their transition from creation to consumption.

Transformation module 400 is a nutritional substance processing system, such as a manufacturer who processes raw materials such as grains into breakfast cereals. Transformation module 400 could also be a ready-to-eat dinner manufacturer who receives the components for a ready-to-eat dinner from preservation module 300 and prepares them into a frozen dinner. While transformation module 400 is depicted as one module, it will be understood that nutritional substances may be transformed by a number of transformation modules 400 on their path to consumption.

Conditioning module 500 is a consumer preparation system for preparing the nutritional substance immediately before consumption by the consumer. Conditioning module 500 can be a microwave oven, a blender, a toaster, a convection oven, a cook, etc. It can also be systems used by commercial establishments to prepare nutritional substance for consumers such as a restaurant, an espresso maker, pizza oven, and other devices located at businesses which provide nutritional substances to consumers. Such nutritional substances could be for consumption at the business or for the consumer to take out from the business. Conditioning module 500 can also be a combination of any of these devices used to prepare nutritional substances for consumption by consumers.

Consumer module 600 collects information from the living entity which consumes the nutritional substance which has passed through the various modules from creation to consumption. The consumer can be a human being, but could also be an animal, such as pets, zoo animals and livestock, which are they themselves nutritional substances for other consumption chains. Consumers could also be plant life which consumes nutritional substances to grow.

Information module 100 receives and transmits information regarding a nutritional substance between each of the modules in the nutritional substance industry 10 including, the creation module 200, the preservation module 300, the transformation module 400, the conditioning module 500, and the consumer module 600. The nutritional substance information module 100 can be an interconnecting information transmission system which allows the transmission of information between various modules. Information module 100 contains a database where the information regarding the nutritional substance resides. Information module 100 can be connected to the other modules by a variety of communication systems, such as paper, computer networks, the internet and telecommunication systems, such as wireless telecommunication systems.

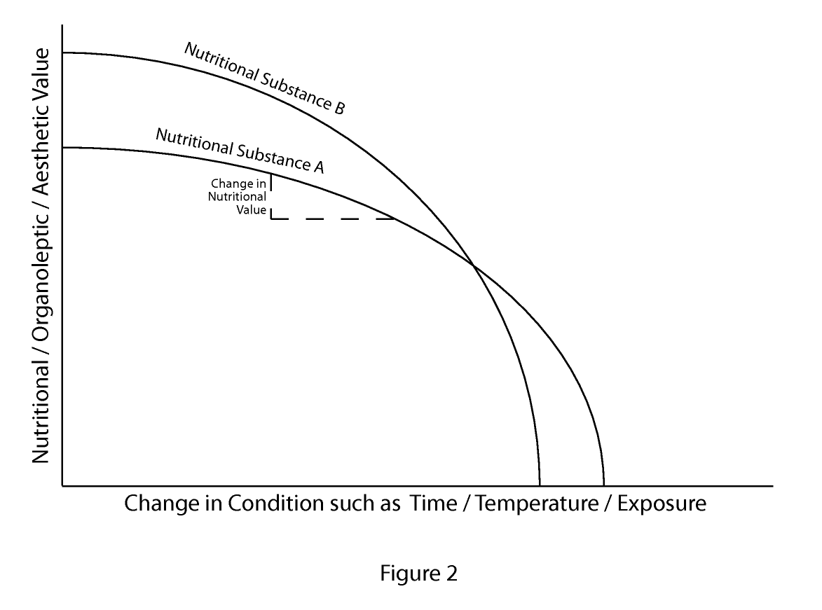

FIG. 2 is a graph showing the function of how a value of a nutritional substance varies over the change in a condition of the nutritional substance. Plotted on the vertical axis of this graph can be either the nutritional value, organoleptic value, or even the aesthetic value of a nutritional substance. Plotted on the horizontal axis can be the change in condition of nutritional substance over a variable such as time, temperature, location, and/or exposure to environmental conditions. This exposure to environmental conditions can include exposure to air, including oxygen, exposure to moisture, exposure to radiation such as heat or sunlight, or exposure to materials such as packaging. The function plotted as nutritional substance A could show the degradation of in the nutritional value of milk over time. Any point on this curve can be compared to another point to measure and/or describe the change in nutritional value. The plot of the degradation in nutritional value of nutritional substance B describes a nutritional substance which starts out with a higher nutritional value than nutritional substance A, but degrades over time more quickly than nutritional substance A.

If, in this example, where nutritional substance A and nutritional substance B are milk, this information regarding the nutritional substance degradation profile of each milk could be used by the consumer in the selection and/or consumption of the milk. If the consumer has this information at time zero when selecting a milk product for purchase, the consumer could consider when the consumer plans to consume the milk, whether that is on one occasion or multiple occasions. For example, if the consumer planned to consume the milk prior to the point when the curve represented by nutritional substance B crosses the curve represented by nutritional substance A, then the consumer should choose the milk represented by nutritional substance B because it has a higher nutritional value until it crosses the curve represented by nutritional substance A. However, if the consumer expects to consume at least some of the milk at a point in time after the time when the curve represented by nutritional substance B crosses the curve represented by nutritional substance A, then the consumer might choose to select the milk represented by the nutritional substance A, even though milk represented by nutritional substance A has a lower nutritional value than the milk represented by nutritional substance B at an earlier time. This change to a desired value in a nutritional substance over a change in the nutritional substance described in FIG. 2 can be measured and/or controlled throughout nutritional substance supply system 10 in FIG. 1.

In FIG. 1, Creation module 200 can dynamically encode nutritional substances to enable the tracking of nutritional, organoleptic, and/or aesthetic value of the nutritional substance. This dynamic encoding can replace and/or complement existing nutritional substance marking systems such as barcodes, labels, and/or ink markings. This dynamic encoding can be used to make nutritional substance information from creation module 200 available to information module 100 for use by preservation module 300, transformation module 400, conditioning module 500, and/or consumption module 600, which includes the ultimate consumer of the nutritional substance. One method of marking the nutritional substance by creation module 200 (or actually any other module in nutritional supply system 10) could include an electronic tagging system, such as the tagging system manufactured by Kovio of San Jose, Calif., USA. Such thin film chips can be used not only for tracking nutritional substances, by can include components to measure attributes of nutritional substances, and record and transmit such information. Such information may be readable by a reader including a satellite-based system. Such a satellite-based nutritional substance information tracking system could comprise a network of satellites with coverage of some or all the surface of the earth, so as to allow information module 100 real time, near real time updates about a particular nutritional substance.

Preservation module 300 includes packers and shippers of nutritional substances. The tracking of nutritional, organoleptic, and/or aesthetic values during the preservation period within preservation module 300 allows for dynamic expiration dates for nutritional substances. For example, expiration dates for dairy products are currently based generally only on time using assumptions regarding minimal conditions at which dairy products are maintained. This extrapolated expiration date is based on a worst-case scenario for when the product becomes unsafe to consume during the preservation period. In reality, the degradation of dairy products may be significantly less than this worst-case. If preservation module 300 could measure or derive the actual degradation information, the actual expiration date could be significantly later in time. This would allow the nutritional substance supply system to dispose of fewer products due to expiration dates. This ability to dynamically generate expiration dates for nutritional substances is of particular significance when nutritional substances contain few or no preservatives. Such products are highly valued throughout nutritional substance supply system 10, including consumers who are willing to pay a premium for nutritional substances with few or no preservatives.

By law, in many localities, food processors such as those in transformation module 400 are required to provide nutritional substance information regarding their products. Often, this information takes the form of a nutritional table applied to the packaging of the nutritional substance. Currently, the information in this nutritional table is based on averages or minimums for their typical product. Using the nutritional substance information from information module 100 provided by creation module 200, preservation module 300, and/or information from the transformation of the nutritional substance by transformation module 400, the food processor could include a nutritional table for the actual nutritional substance being supplied. The information in such a dynamically generated nutritional table could be used by conditioning module 500 in the preparation of the nutritional substance, and/or used by consumption module 600, so as to allow the ultimate consumer the ability to select the most desirable nutritional substance which meets their needs, and/or to track information regarding nutritional substances consumed.

The change in nutritional, organoleptic, and/or aesthetic value by conditioning module 500 is currently not tracked or provided to the consumer. However, using information provided by information module 100 from creation module 200, preservation module 300, transformation module 400, and/or information measured or generated by conditioning module 500, conditioning module 500 could provide consumer with the actual, and/or estimated change in nutritional, organoleptic, and/or aesthetic values of the nutritional substance. Such information regarding the change to nutritional, organoleptic and/or aesthetic value of the nutritional substance could be provided not only to the consumer, but could also be provided to information module 100 for use by creation module 200, preservation module 300, transformation module 400, so as to track, and possibly improve nutritional substances throughout the entire nutritional substance supply system 10.

The information regarding nutritional substances provided by information module 100 to consumption module 600 can replace or complement existing information sources such as recipe books, food databases like www.epicurious.com, and Epicurious apps. Through the use of specific information regarding a nutritional substance from information module 100, consumers can use consumption module 600 to select nutritional substances according to nutritional, organoleptic, and/or aesthetic values. This will allow consumers to make informed decisions regarding nutritional substance additives, preservatives, genetic modifications, origins, traceability, and other nutritional substance attributes. This information can be provided by consumption module 600 through personal computers, laptop computers, tablet computers, and/or smartphones. Software running on these devices can include dedicated computer programs, modules within general programs, and/or smartphone apps. An example of such a smartphone app regarding nutritional substances is the iOS ShopNoGMO from the Institute for Responsible Technology. This iPhone app allows consumers access to information regarding non-genetically modified organisms they may select. Additionally, consumption module 600 may provide information for the consumer to operate conditioning module 500 in such a manner as to preserve nutritional, organoleptic, and/or aesthetic value.

Through the use of nutritional substance information available from information module 100 nutritional substance supply system 10 can track nutritional, organoleptic, and/or aesthetic value. Using this information, nutritional substances travelling through nutritional substance supply system 10 can be dynamically valued and priced according to nutritional, organoleptic, and/or aesthetic values. For example, nutritional substances with longer expiration dates (longer shelf life) may be more highly valued than nutritional substances with shorter expiration dates. Additionally, nutritional substances with higher nutritional, organoleptic, and/or aesthetic values may be more highly valued, not just by the consumer, but also by each entity within nutritional substance supply system 10. This is because each entity will want to start with a nutritional substance with higher nutritional, organoleptic, and/or aesthetic value before it performs its function and passes the nutritional substance along to the next entity.

During the period of implementation of the present inventions, there will be nutritional substances being marketed which including the information, information-enabled nutritional substances, and nutritional substances which are not information enabled, dumb nutritional substances. Information-enabled nutritional substances would be available in virtual internet marketplaces, as well as traditional marketplaces. Because of information provided by information-enabled nutritional substances, entities within the nutritional substance supp0ly system 10, including consumers, would be able to review and select information-enabled nutritional substances for purchase. It should be expected that, initially, the information-enabled nutritional substances would enjoy a higher market value and price than dumb nutritional substances. However, as information-enabled nutritional substances become more the norm, the cost savings from less waste due to degradation of information-enabled nutritional substances could lead to their price actually becoming less than dumb nutritional substances.

For example, the producer of a ready-to-eat dinner would prefer to use corn of a high nutritional, organoleptic, and/or aesthetic value in the production of its product, the ready-to-eat dinner, so as to produce a premium product of high nutritional, organoleptic, and/or aesthetic value. Depending upon the levels of the nutritional, organoleptic, and/or aesthetic values, the ready-to-eat dinner producer may be able to charge a premium price and/or differentiate its product from that of other producers. When selecting the corn to be used in the ready-to-eat dinner, the producer will seek corn of high nutritional, organoleptic, and/or aesthetic value from preservation module 300 that meets its requirements for nutritional, organoleptic, and/or aesthetic value. The packager/shipper of preservation module 300 would also be able to charge a premium for corn which has high nutritional, organoleptic, and/or aesthetic values. And finally, the packager/shipper of preservation module 300 will select corn of high nutritional, organoleptic, and/or aesthetic value from the grower of creation module 200, who will also be able to charge a premium for corn of high nutritional, organoleptic, and/or aesthetic values.

The nutritional, organoleptic, and/or aesthetic value for a nutritional substance tracked through nutritional substance supply system 10 through nutritional substance information from information module 100 can be preferably measured information. However, some or all such nutritional substance information may be derived through measurements of environmental conditions of the nutritional substance as it travelled through nutritional substance supply system 10. Additionally, some or all of nutritional substance information can be derived from data of other nutritional substances which have travelled through nutritional substance supply system 10. Finally, nutritional substance information can also be derived from laboratory experiments performed on other nutritional substances, which may approximate conditions and/or processes to which the actual nutritional substance has been exposed.

For example, laboratory experiments can be performed on bananas to determine effect on nutritional, organoleptic, and/or aesthetic value for a variety of environmental conditions bananas may be exposed to during packaging and shipment in preservation module 300. Using this experimental data, tables and/or algorithms could be developed which would predict the level of nutritional, organoleptic, and/or aesthetic values for a particular banana based upon information collected regarding the environmental conditions to which the banana was exposed during its time in preservation module 300. While the ultimate goal for nutritional substance supply system 10 would be the actual measurement of nutritional, organoleptic, and/or aesthetic values, use of derived nutritional, organoleptic, and/or aesthetic value from experimental information would allow more accurate tracking of nutritional, organoleptic, and/or aesthetic values while technology and systems are put in place to allow actual measurement.

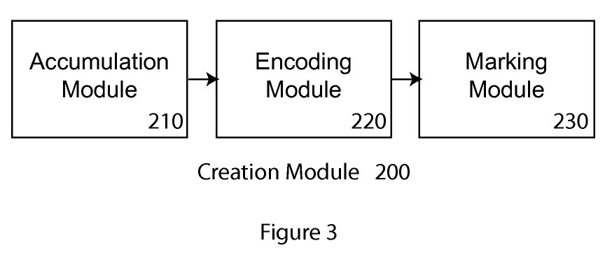

FIG. 3 shows an embodiment of the creation/origin module of the present invention. During the creation/origin of the nutritional substance, creation information regarding the origin and creation of the nutritional substance can be accumulated by accumulation module 210. This creation information is generally known by the creator of the nutritional substance. For example, the grower of sweet corn, knows the land and contacts the seed and traits producer to decide on the seeds that need to be planted in consequence knows the seeds that were planted, knows where the corn seed is planted, when the corn seed was planted, the soil conditions, the source of the water used to irrigate the corn, when the corn is to be harvested or the truffles gathered. Additionally, the grower knows what fertilizers, pesticides, and other substances were used to nourish and protect during growing of the corn.

Accumulation module 210 receives and stores all such creation information that is available from the grower. Accumulation module 210 can take the form of a computer running a data storage program, such as a database.

In another example from the meat industry, the rancher raising a cow for beef knows the cows parental lineage, knows how the cow was raised, whether in a controlled environment or on the open range, and knows when the cow was slaughtered. Additionally, the rancher knows the medical history of the cow, including its general health, any diseases or injuries it suffered, and any medical treatment it received. Additionally, the rancher knows of the cow's immunization history and any medications, supplements and vaccines the cow was given, such as hormones, antibiotics and nutritional supplements. Also the rancher has all the information of the cow's milk production cycle and of the rate of growth, if it has been free range grass fed or in a confined environment and the state and method used to have it slaughtered. This creation information can be accumulated by accumulator module 210 and in the same way we explained the process for the corn a database that could be monitored on real time though a local or global access network.

In another example, the creator of a synthetic nutritional substance knows the source of the molecules used to create the nutritional substance, such as a vitamin complex. A multi-vitamin manufacturer knows the source of the ascorbic acid modules (vitamin C), the source of magnesium and the source of iron, and knows how they were processed into the multi-vitamin. Such creation information would also be accumulated by accumulator module 210 and a database that could be monitored on real time though a local or global access network.

Encoding module 220 takes the nutritional substance creation information from the accumulation module 210 and transforms that information into a form that can be marked on the nutritional substance. The encoded information from encoding module 220 is transmitted to the marking module 230. The encoding module 220 can convert the creation information to the form needed for the marking module, such as a compact, formatted human-readable form. Alternately, encoding module 220 can convert the creation information into a compact machine readable form for imprinting by the marking module 230.

Encoding module 230 can create a label and/or code to be attached, incorporated, or detected, to the nutritional substance that contains the information which specifically pertains to that nutritional substance. The marking module 230 can create a standalone label which is attached to the nutritional substance, which will later be removed before use of the nutritional substance. Such labels can be made of paper, plastic, foil, cardboard, glass or other synthetic material or be integrated with and/or within the nutritional substance through irrigation, fertilization, nourishing, genetics, etc. . . .

Alternately, the marking module can create the label directly on or detect the nutritional substance in a fashion that does not degrade the nutritional substance. Examples include ink made for edible food dye, laser etching of nutritional substance surface, and branding by heat or chemicals or identification of the particular molecules or particular organoleptic characteristics contained or incrusted onto the nutritional substance itself.

Additionally, marking module 230 can generate a label to apply to the nutritional substance which is consumable along with the nutritional substance. Examples include rice paper, edible substances and materials from other nutritional substances.

The label created by marking module 230 may contain the information from accumulation module 210 encoded by encoding module 220 in consumer readable form. Such a label could list the various creation information so that a consumer could read it, for example variety of the banana, where it was grown, when it was planted and harvested, and any non-natural substances that were added to the banana during its cultivation. Such information may be compacted using industry standards that consumers have learned to read and through the combination or mix of ingredients and or sequence on which the ingredients are grown/raised, processed/treated and-or prepared for consumption.

In another example, a package of hamburger meat could include a label containing creation information, such as the lineage of the cow, where and when it was raised and slaughtered, what it was fed, and any nutritional supplements it was given.

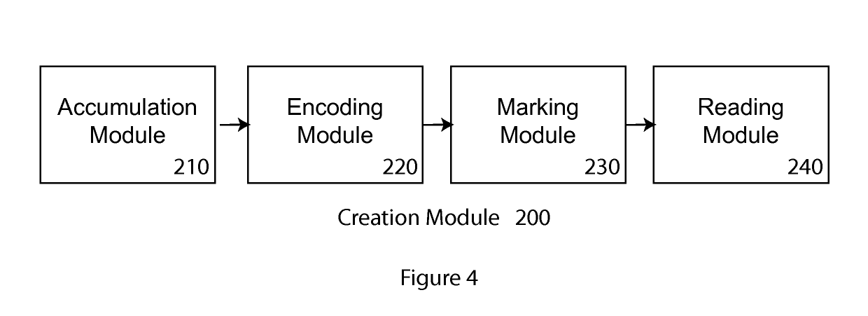

In FIG. 4, the information from accumulation module 210 is encoded by encoding module 220 in a compact, machine readable form which is used by the marking module 230 to create the label. Such a label could be in the form of a barcode or QR Code. In this case, the information is still stored directly on the nutritional substance, but will require reader module 240 to retrieve the information.

In the case of the package of hamburger meat, the user of the hamburger meat would use label reader 240 to retrieve the creation information from the label. If the user is a hamburger patty manufacturer, it will utilize the creation information obtained from label reader 240 to track the hamburger patty products it produces and ships to its customers. It could use such creation information in the preparation of the hamburger patty. For example, such creation information could affect how the hamburger meat is cooked. The user could also pass such creation information along to its customers along with its manufacturing information including in the way it was raised “grass fed” or slaughtered “kosher”.

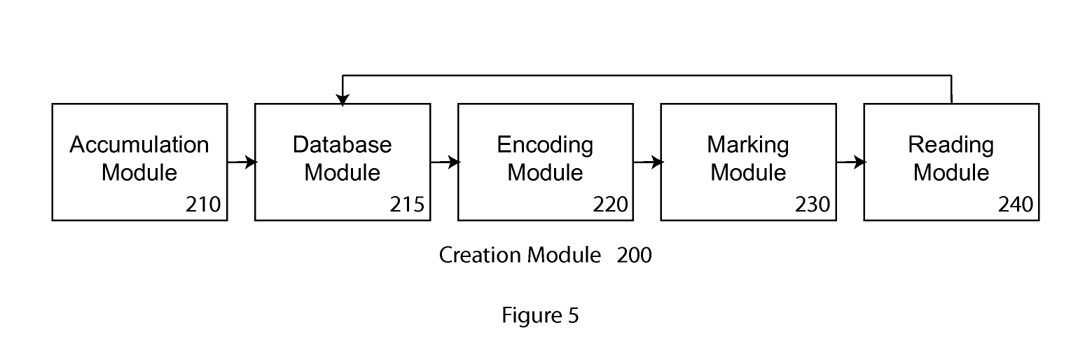

FIG. 5 is an embodiment of the present invention where the creation information is stored in a database for eventual reference by the user of the nutritional substance. Accumulation module 210 accumulates the creation information from the nutritional substance's creation, this information is stored in database module 215 and could be monitored in real time though a local or global access network.

Database module 215 stores the information in a persistent format for later use by the users of the nutritional substance. In its preferred embodiment, encoding module 220 generates a reference code for the creation information stored in database module 215, which it provides to marking module 230 creates a label for the nutritional substance which includes the reference code. The reference code on the label created by the marking module 230 can be in human readable form, such as an alphanumeric code. In such a case, the user of the nutritional substance could use the reference code to obtain the creation information from database 215. Access to database module 215 by a user of the nutritional substance, such as a consumer, might be accomplished by means of a telecommunication system, such as a wireless telecommunication system accessed by means of a personal computing device, such as a tablet computer running a nutritional substance app.

Alternatively, marking module 230 could create a label which includes a machine readable version of the reference code. This could take the form of a barcode or QR Code which could be used to retrieve the creation information from database module 215. In this embodiment, the label reader 240 would read the barcode or QR Code on the label to obtain the reference code which would then be used to retrieve the creation information from database 215.

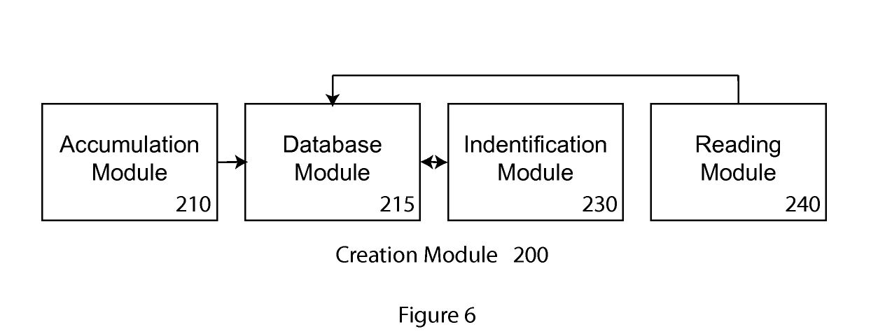

FIG. 6 shows an embodiment of the creation/origin module of the present invention. During the creation/origin of the nutritional substance, creation information regarding the origin and creation of the nutritional substance can be accumulated by accumulation module 210. This creation information is generally known by the creator of the nutritional substance. For example, the grower of sweet corn, knows the land and contacts the seed and traits producer to decide on the seeds that need to be planted in consequence knows the seeds that were planted, knows where the corn seed is planted, when the corn seed was planted, the soil conditions, the source of the water used to irrigate the corn, when the corn is to be harvested or the truffles gathered. Additionally, the grower knows what fertilizers, pesticides, and other substances were used to nourish and protect during growing of the corn.

Accumulation module 210 receives and stores all such creation information that is available from the grower. Accumulation module 210 can take the form of a computer running a data storage program, such as a database.

The creation information is stored in a database module 215 for eventual reference by the user of the nutritional substance. Accumulation module 210 accumulates the creation information from the nutritional substance's creation, which is stored in database module 215.

Database module 220 stores the information in a persistent format for later use by the users of the nutritional substance. In its preferred embodiment, encoding module 220 generates a reference code for the creation information stored in database module 215, which it provides to identification module 230. The identification module 230 identifies a unique identifier of the nutritional substance, which it provides back to the database module 215 for storage with the related creation information from accumulator module 210.

Identification module 230 creates unique identification information for a nutritional substance. In one embodiment, the identification module 230 analyzes the nutritional substance to obtain a unique identifier for the nutritional substance that can be used to reference creation information accumulated by accumulation module 210 and stored in database 215. For example, a particular variety of corn may have certain molecules in it that are unique to where and/or how it was grown. The identification module 230 would provide a link back to the creation information database module 215.

Reader module 240 would be used by the user of the nutritional substance to obtain the unique identifier necessary to retrieve the creation information from database 215. For example, the user of sweet corn received from a grower would use reader module 240 to obtain the unique identifier of corn it has received to retrieve the creation information from database module 215 for that corn. That information could be used in the processing of the corn, such as into canned sweet corn. Additionally, such creation information could be passed along to the consumer of the sweet corn with possibly the manufacturing information of the canned sweet corn.

In another embodiment of the present invention, a unique identifier could be added or formed within the nutritional substance. Such a unique identifier would not harm or degrade or affect the aesthetic value of the nutritional substance. It also would not be dangerous to the consumer of the product. In short, it should be transparent to the user of the nutritional substance. Such unique identifiers can take the form of specific molecules or chemicals not naturally found in the nutritional substance. It also could take the form of nanoparticles specifically designed to form a unique identifier.

Further, a unique identifier could be created in a product by adding a substance which interacts with some known feature of a specific nutritional substance to form a unique identifier. A chemical compound which interacts with a compound naturally occurring within a nutritional substance could create a unique identifier for that product. For example, if cattle are raised on different ranges which include food that has different amounts of a certain chemical which is incorporated into their tissue, a substance could be added during processing of the resulting meat which would interact differently with the substances obtained in the cow to produce differing unique identifiers. This would allow a particular unique identifier in a particular piece of beef to be traced back to its creation information.

Access to database module 215 by a user of the nutritional substance, such as a consumer, might be accomplished by means of a telecommunication system, such as a wireless telecommunication system accessed by means of a personal computing device, such as a tablet computer running a nutritional substance app.

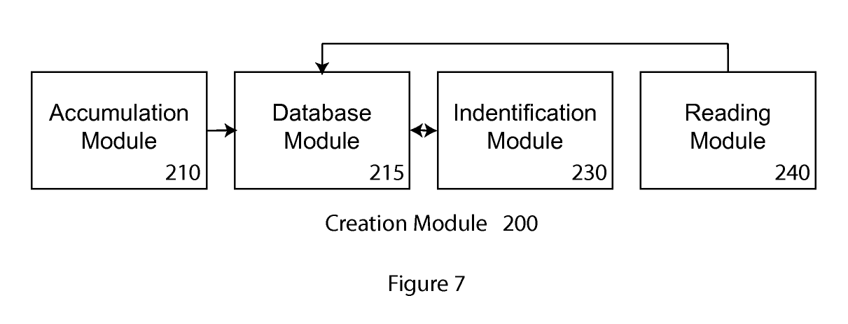

FIG. 7 shows an embodiment of the creation/origin module of the present invention. During the creation/origin of the nutritional substance, creation information regarding the origin and creation of the nutritional substance can be accumulated by accumulation module 210. This creation information is generally known by the creator of the nutritional substance. For example, the grower of sweet corn, knows the land and contacts the seed and traits producer to decide on the seeds that need to be planted in consequence knows the seeds that were planted, knows where the corn seed is planted, when the corn seed was planted, the soil conditions, the source of the water used to irrigate the corn, when the corn is to be harvested or the truffles gathered. Additionally, the grower knows what fertilizers, pesticides, and other substances were used to nourish and protect during growing of the corn.

Accumulation module 210 receives and stores all such creation information that is available from the grower. Accumulation module 210 can take the form of a computer running a data storage program, such as a database.

The creation information is stored in a database module 215 for eventual reference by the user of the nutritional substance. Accumulation module 210 accumulates the creation information from the nutritional substance's creation, which is stored in database module 215.

Database module 220 stores the information in a persistent format for later use by the users of the nutritional substance. In its preferred embodiment, encoding module 220 generates a reference code for the creation information stored in database module 215, which it provides to identification module 230. The identification module 230 identifies a unique identifier of the nutritional substance, which it provides back to the database module 215 for storage with the related creation information from accumulator module 210.

Identification module 230 creates unique identification information for a nutritional substance. In one embodiment, the identification module 230 analyzes the nutritional substance to obtain a unique genetic identifier for the nutritional substance that can be used to reference creation information accumulated by accumulation module 210 and stored in database 215. For example, a particular variety of corn may have certain genes in it that are unique to where and/or how it was grown. The identification module 230 would provide a link back to the creation information database module 215. For example, such a unique genetic identify could be expressed in the corn by a unique color of the husk or silk.

Reader module 240 would be used by the user of the nutritional substance to obtain the unique genetic identifier necessary to retrieve the creation information from database 215. For example, the user of sweet corn received from a grower would use reader module 240 to obtain the unique genetic identifier of corn it has received to retrieve the creation information from database module 215 for that corn. That information could be used in the processing of the corn, such as into canned sweet corn. Additionally, such creation information could be passed along to the consumer of the sweet corn with possibly the manufacturing information of the canned sweet corn.

In another embodiment of the present invention, a unique genetic identifier could be added or formed within the genetic code of the nutritional substance. Such a unique genetic identifier would not harm or degrade or affect the aesthetic value of the nutritional substance. It also would not be dangerous to the consumer of the product. In short, it should be transparent to the user of the nutritional substance. Such unique identifiers can take the form of specific gene sequence not naturally found in the nutritional substance. It also could take the form of gene sequence which expresses a specifically designed to form a unique identifier. Alternately, such an added or modified gene sequence could be completely dormant, but readable by reader module 240, by decoding part or all of the gene sequence of the nutritional substance.

Access to database module 215 by a user of the nutritional substance, such as a consumer, might be accomplished by means of a telecommunication system, such as a wireless telecommunication system accessed by means of a personal computing device, such as a tablet computer running a nutritional substance app.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. Any claims intended to be treated under 35 U.S.C. §112, ¶6 will begin with the words “means for.” Accordingly, the applicant reserves the right to add additional claims after filing the application to pursue such additional claim forms for other aspects of the invention.

1. An information identification system for nutritional substances comprising:
information relating to creation or origin of a particular nutritional substance and to a change in the nutritional substance;
an identifier on, or part of, the particular nutritional substance containing the information;
reader for reading the identifier; and
information retriever obtaining the information regarding the particular nutritional substance contained in the identifier.

2. An information identification system for nutritional substances comprising:
information relating to creation or origin of a particular nutritional substance and to a change in the nutritional substance;
information storage for storing such information;
an identifier on, or part of, the particular nutritional substance referencing such information;
reader for reading the identifier; and
information retriever obtaining such information from information storage regarding the particular nutritional substance referenced by such identifier in the identifier.

3. An information identification system for nutritional substances comprising:
information relating to creation or origin of a particular nutritional substance and to a change in the nutritional substance;
information storage the information;
an identifier on or part of the particular nutritional substance;
identifier reader for reading the identifier; and
retrieval obtaining information regarding the particular nutritional substance from the means for storage.

4. An information identification system for nutritional substances according to claim 1 wherein the identifier is a label/tag which contains the information relating to particular nutritional substance.

5. An information identification system for nutritional substances according to claim 2 wherein the identifier is a label which references the information relating to particular nutritional substance.

6. An information identification system for nutritional substances according to claim 2 wherein information relating to particular nutritional substance comprises nutritional, organoleptic, and/or asthenic values.

7. An information identification system for nutritional substances according to claim 2 wherein information storage comprises an electronic storage device or system.

8. An information identification system for nutritional substances according to claim 2 wherein information storage comprises a computer.

9. An information identification system for nutritional substances according to claim 2 wherein information storage comprises a computer database.

10. An information identification system for nutritional substances according to claim 2 wherein the identifier is a human readable label.

11. An information identification system for nutritional substances according to claim 2 wherein the identifier is a computer readable label.

12. An information identification system for nutritional substances according to claim 2 wherein the identifier is a computer readable label comprising a barcode label.

13. An information identification system for nutritional substances according to claim 2 wherein the identifier is a computer readable label comprising a QR code label.

14. An information identification system for nutritional substances according to claim 2 wherein the identifier is a computer readable label comprising a radio frequency label.

15. An information identification system for nutritional substances according to claim 2 wherein the identifier is a computer readable label comprising an electronically readable label.

16. An information identification system for nutritional substances according to claim 2 wherein such reader comprises an optical reader.

17. An information identification system for nutritional substances according to claim 2 wherein such reader comprises a radio frequency reader.

18. An information identification system for nutritional substances according to claim 2 wherein such reader comprises an electronic reader.

19. An information identification system for nutritional substances according to claim 2 wherein such information retriever comprises a computer.

20. An information identification system for nutritional substances according to claim 2 wherein such information retriever comprises a database.

21. An information identification system for nutritional substances comprising:
information relating to creation or origin of a particular nutritional substance and to a change in the nutritional substance;
an identifier on or part of the particular nutritional substance containing the information;
means for reading the identifier; and
means for obtaining the information regarding the particular nutritional substance contained in the identifier.

22. An information identification system for nutritional substances comprising:
Information relating to creation or origin of a particular nutritional substance and to a change in the nutritional substance;
means for storing the information;
an identifier on or part of the particular nutritional substance;
means for reading the identifier; and
means obtaining information regarding the particular nutritional substance from the means for storage.

23. An information identification system for nutritional substances according to claim 22 wherein the identifier is a natural unique attribute of the particular nutritional substance which references the Information relating to particular nutritional substance.

24. An information identification system for nutritional substances according to claim 22 wherein the identifier is an artificially added unique attribute of the particular nutritional substance which references the Information relating to particular nutritional substance.

25. An information identification system for nutritional substances comprising:
Information relating to creation or origin of a particular nutritional substance and to a change in the nutritional substance;
an identifier on or part of the particular nutritional substance containing the information;
means for reading the identifier; and
means for obtaining the information regarding the particular nutritional substance contained in the identifier.

26. An information identification system for nutritional substances comprising:
Information relating to creation or origin of a particular nutritional substance and to a change in the nutritional substance;
means for storing the information;
an identifier on or part of the particular nutritional substance;
means for reading the identifier; and
means obtaining information regarding the particular nutritional substance from the means for storage.

27. An information identification system for nutritional substances according to claim 26 wherein the identifier is a unique genetic attribute of the particular nutritional substance which references the Information relating to particular nutritional substance.

28. An information identification system for nutritional substances according to claim 26 wherein the identifier is an artificially added or modified unique genetic attribute of the particular nutritional substance which references the Information relating to particular nutritional substance.

29. A nutritional substance tracking system for tracking the nutritional, organoleptic and/or aesthetic values of a nutritional substance at creation of said nutritional substance, comprising:
information related to said nutritional, organoleptic and/or aesthetic values at creation or origin of said nutritional substance and to a change in said nutritional, organoleptic and/or aesthetic value of said nutritional substance;
identifier associated with said nutritional substance;
information storage containing said information referenced to said identifier;
reader for obtaining the identifier;
retriever for retrieving said formation from said information storage using said identifier.

30. A method of tracking a nutritional substance comprising the steps of:
obtaining source information for a particular nutritional substance and information relating to change in the nutritional substance;
identifying said nutritional substance;
associating said source information with said identified nutritional substance.

31. The method of tracking a nutritional substance of claim 30 wherein the particular nutritional substance is identified by marking the nutritional substance.

32. The method of tracking a nutritional substance of claim 30 wherein the particular nutritional substance is identified by labeling the nutritional substance with a barcode.

33. The method of tracking a nutritional substance of claim 30 wherein the particular nutritional substance is identified by labeling the nutritional substance with a QR code.

34. The method of tracking a nutritional substance of claim 30 wherein the particular nutritional substance is identified by unique attribute or property of the nutritional substance.

35. The method of tracking a nutritional substance of claim 30 wherein the particular nutritional substance is identified by unique inherent attribute or property of the nutritional substance.

36. The method of tracking a nutritional substance of claim 30 wherein the particular nutritional substance is identified by unique induced attribute or property of the nutritional substance.

37. The method of tracking a nutritional substance of claim 30 wherein the particular nutritional substance is identified by unique inherent genetic attribute or property of the nutritional substance.

38. The method of tracking a nutritional substance of claim 30 wherein the particular nutritional substance is identified by unique induced genetic attribute or property of the nutritional substance.
